(19) United States
(12) Patent Application Publication
(10) Pub. No.: US 2015/0007255 A1
(43) Pub. Date: Jan. 1, 2015

(54) TERMINAL AND METHOD FOR UPDATING APPLICATIONS THEREOF

(71) Applicant: Samsung Electronics Co., Ltd., Suwon-si (KR)

(72) Inventor: Byungwook KIM, Suwon-si (KR)

(21) Appl. No.: 14/307,925

(22) Filed: Jun. 18, 2014

(30) Foreign Application Priority Data
Jun. 27, 2013 (KR) 10-2013-0074157

(51) Int. Cl. H04L 29/06; H04L 29/08

(52) U.S. Cl. CPC H04L 63/101; H04L 67/1095
USPC 726/1

(57) ABSTRACT

A method for updating an application and a terminal implemented with the method are provided. The method includes determining update intervals of a plurality of applications installed in the terminal, calculating a common synchronization timing based on the update intervals of the plurality of applications, and determining, when an update time of an update target application arrives, whether to allow updating of the update target application according to at least one of a network block list and a network permit list.

### CROSS-REFERENCE TO RELATED APPLICATION(S)

This application claims the benefit under 35 U.S.C. §119(a) of a Korean patent application filed on Jun. 27, 2013 in the Korean Intellectual Property Office and assigned Serial number 10-2013-0074157, the entire disclosure of which is hereby incorporated by reference.

### TECHNICAL FIELD

The present disclosure relates to a terminal and method for managing application data for use therein. More particularly, the present disclosure relates to a method for updating a plurality of applications simultaneously and a terminal providing the same.

### BACKGROUND

With the advance of mobile communication technology, a mobile terminal has evolved to be a multifunctional device supporting data communication and services as well as conventional voice telephony. Mobile terminals, such as a smartphone, and a sophisticated network supporting high data rates have make it possible for users to use various data services, anytime, anywhere.

The mobile terminal, such as the smartphone, allows users to install various applications, such as email, a Social Network Service (SNS), and Instant Messaging (IM) applications. These applications need the terminal to connect to the network for data updates. In order to accomplish data update, each application is configured with a data synchronization interval set to a value selected by the user. Typically, the synchronization interval may be set to a certain value, e.g. 5 minutes, 15 minutes, 30 minutes, 1 hour, and 4 hours, according to the user's preference. If the user wants to update the data of a certain application in or near to real time, it is preferred to set the synchronization interval to a short time value.

The terminal requests the network for data updates at the synchronization interval configured for the corresponding application. The network transmits corresponding data to the terminal in response to the request.

The operation mode of the terminal transitions from an idle mode to an active mode whenever each application performs the data update. Accordingly, if a large number of applications configured with respective synchronization intervals are running on the terminal, the transition from the idle mode to the active mode occurs frequently.

FIG. 1 is a diagram illustrating operation mode transitions caused by synchronization intervals of applications in a technology according to the related art.

Referring to FIG. 1, in a case where the applications A, B, and C have different synchronization intervals, the terminal transitions from the idle mode to the active mode frequently, resulting in reduction of the idle mode time. As the number of transitions between the idle mode and active mode increases, the mode switching signaling increases, resulting in an increase of unnecessary power consumption.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for controlling data update intervals of applications running on the terminal efficiently.

In accordance with an aspect of the present disclosure, an application update method of a terminal is provided. The method includes determining update intervals of a plurality of applications installed in the terminal, calculating a common synchronization timing based on the update intervals of the plurality of applications, and determining, when an update time of an update target application arrives, whether to allow updating of the update target application according to at least one of a network block list and a network permit list.

In accordance with another aspect of the present disclosure, a terminal for updating an application is provided. The terminal includes a storage unit configured to store at least one of network block list and a network permit list, a control unit configured to determine update intervals of a plurality of applications, to calculate a common synchronization timing based on the update intervals of the plurality of applications, and to determine, when an update time of an update target application arrives, whether to allow update of the update target application according to the at least one of the network block list and the network permit list, and a communication unit configured to perform at least one of transmitting and receiving data of the update target application according to whether the application allows the update of the application.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating operation mode transitions caused by synchronization intervals of applications in a technology according to the related art;

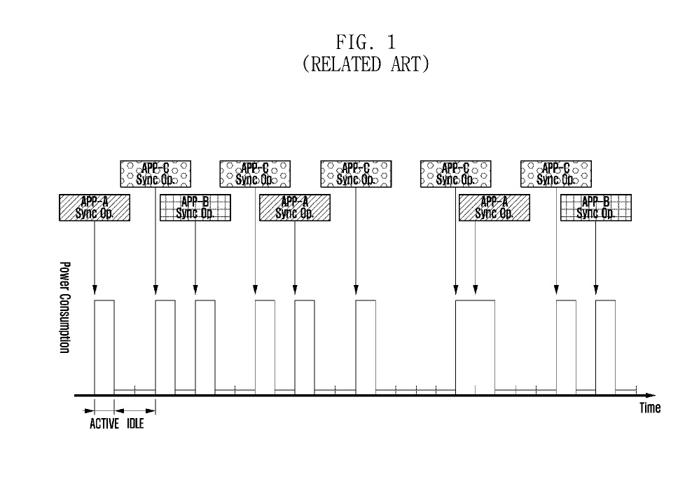

FIG. 2 is a block diagram illustrating a configuration of a terminal according to an embodiment of the present disclosure;

FIG. 3 is a diagram illustrating a configuration of an Operating System (OS) of a control unit for synchronizing update intervals of applications according to an embodiment of the present disclosure;

FIG. 4A is a flowchart illustrating the application update synchronization method based on a network block list according to an embodiment of the present disclosure;

FIG. 4B is a flowchart illustrating an application update synchronization method based on a network permit list according to an embodiment of the present disclosure;

FIG. 4C is a flowchart illustrating a common synchronization timing calculation procedure of an application update synchronization method according to an embodiment of the present disclosure;

FIG. 5A is a diagram illustrating a screen display showing a menu for configuring a network block list for use in an application update synchronization method according to an embodiment of the present disclosure;

FIG. 5B is a diagram illustrating a screen display showing a menu for configuring a network permit list for use in an application update synchronization method according to an embodiment of the present disclosure;

FIG. 6A is a diagram illustrating application update operations with and without applying a network block list in an application update synchronization method according to an embodiment of the present disclosure; and

FIG. 6B is a diagram illustrating application update operations with and without applying a network permit list in an application update synchronization method according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

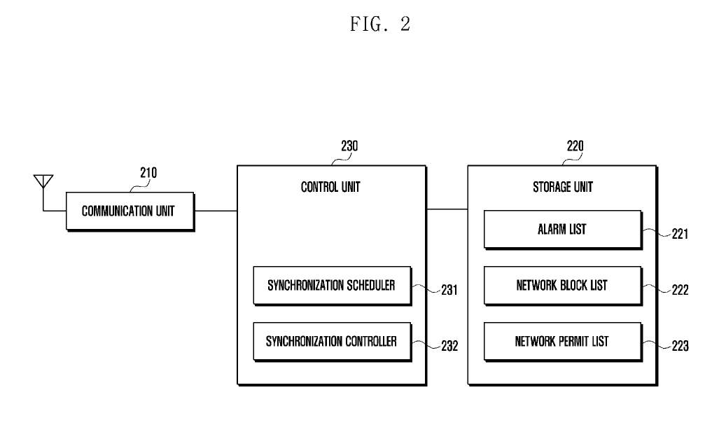

FIG. 2 is a block diagram illustrating a configuration of a terminal according to an embodiment of the present disclosure.

Referring to FIG. 2, the terminal according to an embodiment of the present disclosure includes a communication unit 210, a storage unit 220, and a control unit 230.

The communication unit 210 provides data communication with an external device under the control of the control unit 230. That is, the communication unit 210 establishes a communication channel with a base station for data communication associated with text messaging and image transfer as well as voice, data, and video communication. For this purpose, the communication unit 210 may include a Radio Frequency (RF) transmitter for up-converting and amplifying a transmission signal and an RF receiver for low noise amplifying and down-converting the received signal. The communication unit 210 also may communicate data with a network at a predetermined update interval. At this time, the communication unit 210 may transmits a data request message to the network interoperating with the application that is to be updated under the control of the control unit 230.

According to an embodiment of the present disclosure, synchronizing an application includes transmitting and/or receiving messages for maintaining a current connection, e.g. a keep-alive message, as well as transmitting and receiving the modified information to and from an external entity, such as an external electronic device.

The storage unit 220 stores programs corresponding to operations of the terminal and data processing in the terminal. Particularly, according to an embodiment of the present disclosure, the storage unit 220 may store an alarm list 221, including update intervals of individual applications. The alarm list 221 also includes common synchronization time information as a basic time unit for synchronization under the control of the control unit 230.

The control unit 230 controls states and operations of components constituting the terminal. Particularly, according to an embodiment of the present disclosure, the control unit 230 may synchronize the update intervals of the applications needing periodic update. In further detail, the control unit 230 determines whether an application update interval configuration mode is selected. Here, the application update interval configuration mode is an operation mode activated when a periodic update-triggering application registration item is selected and/or when an update interval change item is selected in a preferences page of an installed application.

The control unit 230 may synchronize the update intervals of the application needing periodic data updates from among all of the applications running on the terminal. The applications needing periodic data update may include applications needing periodic updates of user profile-based information, like data received from a communication peer through email, schedule organization information, and network information. A representative application needing periodic data update is a Social Network Service (SNS) application, such as Facebook and Twitter.

The control unit 230 may synchronize the update interval of a certain application with the update intervals of other applications by controlling a synchronization scheduler 231 and a synchronization controller 232.

The control unit 230 calculates a common synchronization timing based on the update intervals of the applications needing periodic data updates and determines, when the update time of each application arrives, whether to perform updates of the corresponding application according to the common synchronization timing.

The control unit 230 manages the data updates of the applications based on the common synchronization timing. Whenever an application needing periodic updates is installed, the control unit 230 may recalculate the common synchronization timing based on the update intervals of the individual applications.

The synchronization scheduler 231 calculates the common synchronization timing based on update intervals of the applications needing periodic updates and adjusts the update interval of each application according to the common synchronization timing.

In detail, the synchronization scheduler 231 generates an alarm signal corresponding to the applications needing periodic updates based on the common synchronization timing and per-application update intervals in order to schedule the update synchronization interval needing periodic updates.

The synchronization scheduler 231 calculates a greatest common divisor between an update interval of a registration-requested application and a basic synchronization unit interval that is stored previously. The basic synchronization unit interval denotes a potential update interval synchronized among the applications needing periodic updates that are currently running, i.e., currently being executed, on the terminal currently. Whenever an application needing periodic updates is registered, the synchronization scheduler 231 compares the basic synchronization unit interval with the update interval of the newly registered application and calculates the greatest common divisor between two intervals as the new basic synchronization unit interval.

The applications needing the periodic update may have different update intervals, and the synchronization scheduler 231 configures the greatest common divisor, from among the per-application update intervals, as the basic synchronization unit interval. If the synchronization scheduler 231 configures the greatest common divisor of the per-application update intervals as the basic synchronization unit interval, then the basic synchronization unit interval is stored in the storage unit 220 as common synchronization timing

In a case where the update intervals of the applications A and B are Tₐ and T_{b}, respectively, the greatest common divisor between the two update intervals is calculated as Equation (1):

T_{gcd}=gcd(Tₐ, T_{b}) Equation (1)

wherein T_{gcd} denotes the basic synchronization unit interval which is stored as the common synchronization timing

If a new application is registered after the determination of the basic synchronization unit interval, the greatest common divisor between the basic synchronization unit interval and the update interval of the newly registered application is calculated as Equation (2):

T_{gcd}=gcd(T_{gcd-old}, Tₓ) Equation (2)

wherein Tₓ denotes the update interval of the newly registered application, and T_{gcd-old} denotes the old basic synchronization unit interval, i.e. the common synchronization timing.

The synchronization scheduler 231 adjusts the update interval of the application selected for registration based on the calculated greatest common divisor. The synchronization scheduler 231 schedules the data update of the corresponding application based on the calculated basic synchronization unit interval. The synchronization scheduler 231 first determines whether the update interval of the application selected for registration and the previously stored common synchronization timing are relatively prime. If the two intervals are relatively prime, then the synchronization scheduler 231 maintains the old common synchronization timing as the basic synchronization unit interval without newly calculating the basic synchronization unit interval.

In a case where the update period of the application to be registered is 6 minutes, and the previously stored common synchronization timing is 7 minutes, the greatest common divisor between the two intervals, 6 minutes and 7 minutes, is 1. That is, the two intervals are relatively prime. In this case, the synchronization scheduler 231 configures the previously stored common synchronization timing, i.e. 7 minutes, as the basic synchronization unit interval. The configured basic synchronization unit interval is stored in the storage unit 220 as the common synchronization timing.

Next, the synchronization scheduler 231 adjusts a start time of the update of the registered application so as to match with the update intervals of other applications. That is, the synchronization scheduler 231 matches the start time for when the update interval of the application is applied with the start time of the updates of the other applications of which update intervals are synchronized.

If an update time of an application arrives according to the common synchronization timing and the update interval of the corresponding application, the synchronization controller 232 retrieves a network block list 222 and/or a network permit list 23 in order to determine whether to block and/or permit update synchronization of the corresponding application.

Here, the network block list 222 is the list of applications for which update synchronization is blocked between the network and the application, and the network permit list 223 is the list of the application for which update synchronization is permitted between the network and the applications. According to an embodiment of the present disclosure, the storage unit 220 stores at least one of the network block list 222 and the network permit list 223. Here, the network block list 222 or the network permit list 223 may be received from an outside source, such as an external electronic device, through the communication unit 210 and/or may be designated and/or generated by the user.

The user may determine the applications needing periodic update so as to add the applications not needing periodic updates to the network block list 222 and/or add the applications needing periodic updates to the network permit list 223. In a case where a certain application has contributed to the calculation of the common synchronization timing with other applications, if the certain application is included in the network block list 222, the synchronization controller 232 blocks its network access.

In the case of determining whether to permit update synchronization of the target application by referencing the network permit list 223, the synchronization controller 232 permits the network access of only the applications included in the network permit list 223. At this time, although the applications that are not listed in the network permit list 223 have contributed to the calculation of the common synchronization timing, the synchronization controller 232 blocks the network access of the applications that are not listed in the network permit list 223.

For example, if the update intervals of applications A, B, and C are 10 minutes, 20 minutes, and 5 minutes, respectively, the common synchronization timing is processed as follows. Since the greatest common divisor of the update intervals of the applications A, B, and C is 5 minutes, the synchronization scheduler 231 sets the common synchronization timing of the applications A, B, and C to 5 minutes and stores the common synchronization timing in the storage unit 220 under the control of the control unit 230.

If another application D, having the update interval of 15 minutes is registered newly, the common synchronization timing is recalculated to be 5 minutes as the greatest common divisor of the applications A, B, C, and D.

However, if the update interval of the application D is 7 minutes rather than 15 minutes, i.e. if the greatest common divisor between the common synchronization timing of the applications A, B, and C (5 minutes) and the update interval of the application D (7 minutes) is 1, the synchronization scheduler 231 maintains the common synchronization update interval of 5 minutes without recalculating the common synchronization timing

The synchronization scheduler 231 adds the application D to the alarm list 221, and the application D connects to the network at the update interval of 7 minutes independently of the common synchronization timing. The control unit 230 updates the alarm list 221 at the update interval of the applications A, B, and C. The synchronization scheduler schedules the updates such that the start times of the updates of the applications A, B, and C are identical among each other. Then, when the third update time of the application C, i.e. 10 minutes after the first update of the applications A, B, and C, arrives, the second update time of the application A arrives too.

Likewise, when the fifth update time of the application C, i.e. 20 minutes after the first update of the applications A, B, and C, arrives according to the common synchronization timing, the third update time of the application A and the second update time of the application B arrive too. When the update time of each application arrives, the synchronization scheduler 231 generates an alarm signal corresponding to the applications A, B, C, and D and the synchronization controller 232 in order to notify of the network access timing.

If the network block list 222 includes the applications B and D, then the applications B and D are blocked from connecting to the network, although the applications A and C may connect to the network at the basic synchronization unit interval of 5 minutes as the common synchronization timing. If the network permit list 223 includes the applications A and C, the applications A and C may connect to the network at the basic synchronization unit interval of 5 minutes as the common synchronization timing, while the network connection of the applications B and D are blocked.

Although not shown in the drawing, the terminal may include other components depending on the functionality of the terminal For example, the terminal may include a display unit for displaying the data corresponding to the operation state of the terminal, an input unit for generating a signal corresponding to the control unit 230 in response to the user input, a camera unit for taking images, a digital broadcast reception unit for receiving digital broadcast data, an audio processing unit for processing audio data including voice, and any other similar and/or suitable element that may be included in the terminal.

The above-described terminal may synchronize the update intervals of a plurality of applications in a common interval. The terminal may update a plurality of applications simultaneously at the common update interval. The terminal may sort the applications by update necessity in order to block and/or permit the update of the individual applications selectively, resulting in reduction of power consumption.

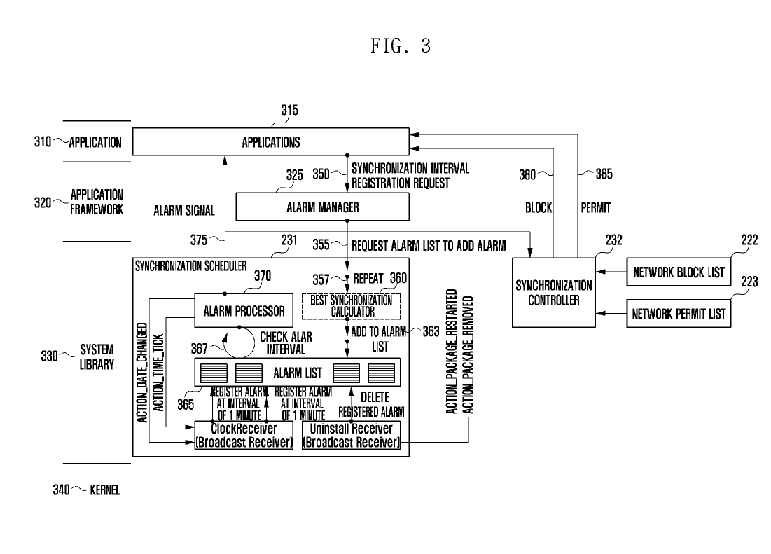

FIG. 3 is a diagram illustrating a configuration of an Operating System (OS) of a control unit for synchronizing update intervals of applications according to an embodiment of the present disclosure.

Referring to FIG. 3, the OS of the control unit 230 includes an application layer 310, an application framework layer 320, a system library layer 330, and a kernel 340.

The application layer 310 allows applications 315 to operate. The application framework layer 320 includes classes and libraries implementing standard application program structures. That is, the application framework layer manages the lifecycles of applications, processing events, and controls applications. Particularly, according to an embodiment of the present disclosure, the application framework layer 320 includes an alarm manager 325 which requests for synchronization of update intervals of applications. The system library layer 330 is a set of datasets and files storing parts of the OS. Particularly, according to an embodiment of the present disclosure, the system library layer 330 includes the synchronization scheduler 231 for synchronizing the update intervals of the applications. The kernel layer 340 is responsible for interrupt processing, process management, memory management, system management, and programing interface provision, as the core of providing the basic functions of the OS. That is, the kernel may be a kind of application for controlling the hardware.

With the above-structured OS, the control unit 230 operates as follows. The application layer 310, at operation 350, sends a synchronization interval registration request to the alarm manager 325 of the application framework layer 320 for synchronization interval registration in order to synchronize the update interval of the application 315 to be registered. Then, at operation 355, the alarm manager 325 requests the synchronization scheduler 231 to add an alarm to an alarm list 365. This process of operation 355 is performed repeatedly as operation 357 whenever an application is registered.

Then the synchronization scheduler 231 calculates the scheduling synchronization interval of the corresponding application a best synchronization calculator 360, and, at operation 363, adds the calculated scheduling synchronization interval to the alarm list 365. The synchronization scheduler 231 determines the scheduling synchronization intervals included in the alarm list 365 at operation 367 in order to determine the alarm interval for notifying the application layer 310 of update time using an alarm processor 370. If the alarm time arrives, the synchronization scheduler 231 generates an alarm signal corresponding to the application layer 310 and the synchronization controller 232 in order to notify of the scheduling synchronization interval of the application at operation 375.

At this time, the synchronization controller 232 retrieves the network block list 222 and/or the network permit list 223 stored in the storage unit 220 in order to determine whether to allow update synchronization of the corresponding application. Although a certain application has contributed to the calculation of the common synchronization timing with other applications, if the certain application is included in the network block list 222, the synchronization controller 232 blocks its network access at operation 380. In contrast, if the application is not included in the network block list 222, the synchronization controller 232 allows the application to connect to the network at operation 385.

In the case of using the network permit list 223 to determine whether to allow for the update synchronization of the corresponding application, if the application is not included in the network permit list 223, the synchronization controller 232 blocks the network connection of the corresponding application the synchronization controller 232 blocks the network connection of the corresponding application at operation 380. If the application is included in the network permit list 223, the synchronization controller 232 allows and/or permits the network connection of the corresponding application at operation 385.

That is, if the alarm signal corresponding to the corresponding application is received at operation 375, then the synchronization scheduler 231 retrieves the network block list 222 and/or the network permit list stored in the storage unit 220 in order to determine whether to allow update synchronization of the corresponding application.

If the corresponding application is included in the network block list 222, and although the corresponding application has contributed to the calculation of the common synchronization timing with other application, the synchronization controller 232 blocks the network connection of the corresponding application at operation 380. If the corresponding application is not included in the network block list 222, then the synchronization controller 232 allows for the network connection of the application at operation 385. In the case of using the network permit list 223 to determine whether to allow for the update synchronization of the corresponding application, the synchronization controller 232 allows only the applications listed in the network permit list 223 to connect to the network at operation 380. If the application is not included in the network permit list 223, the synchronization controller 232 blocks the network connection of the corresponding application at operation 385

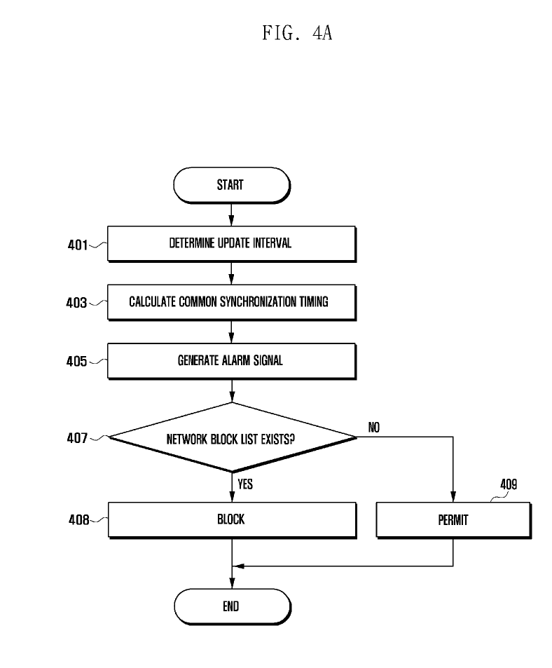

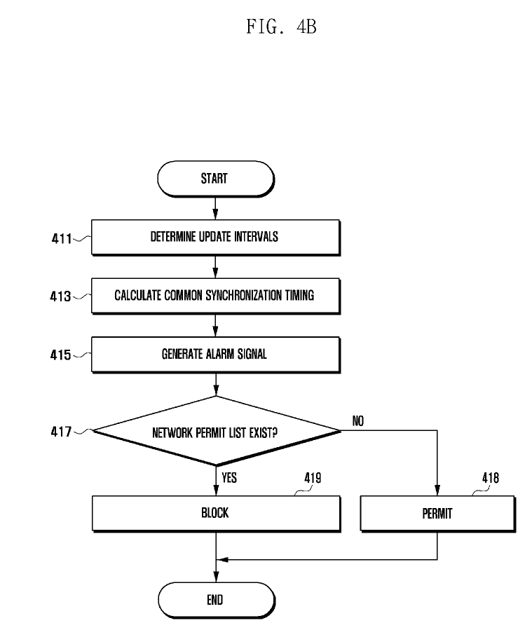

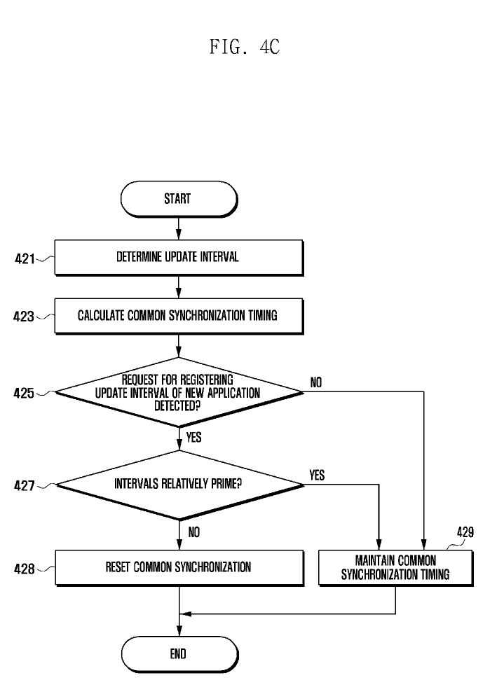

FIG. 4A is a flowchart illustrating an application update synchronization method based on a network block list according to an embodiment of the present disclosure.

Referring to FIG. 4A, the terminal determines the update intervals of the applications installed in the terminal at operation 401. Here, the applications are the applications needing periodic receipt of data from the outside. The SNS applications, such as Facebook and Twitter, are representative of applications needing periodic data updates, however, the present disclosure is not limited thereto, and any application needing periodic data updates may be a representative of the applications described according to the embodiment of FIG. 4A.

The terminal calculates the common synchronization timing for sharing a synchronized interval based on the update intervals of the applications at operation 403. The applications needing periodic updates may have different update intervals, and the basic synchronization unit interval is determined based on the greatest common divisor of the update intervals of the individual applications. If the terminal configures the greatest common divisor of the update intervals as the basic synchronization unit interval, then the common synchronization timing is calculated based on the basic synchronization unit interval. The update intervals of the individual applications are listed in the alarm list. At this time, the terminal synchronizes the start times of the updates of the applications.

If a network connection time of the application, which is determined according to the common synchronization timing and the per-application update interval, arrives, then the terminal generates an alarm signal at operation 405.

If the alarm signal is detected, i.e. if the network access time of the corresponding application arrives according to the common synchronization timing, then the terminal determines the network block list 222 exists in order to determine whether to allow update synchronization of the corresponding application at operation 407. Here, the network block list 222 lists the applications of which update synchronizations with the network are blocked. The network block list 222 may be received from the outside via the communication unit 210 and/or may be designated by the user.

Although a certain application has contributed to the calculation of the common synchronization timing with other applications, if the certain application is included in the network block list 222, then the terminal blocks a network connection of the certain application at operation 408. On the other hand, if the corresponding application is not included in the network block list 222, then the terminal permits the network access of the corresponding application at operation 409.

FIG. 4B is a flowchart illustrating an application update synchronization method based on a network permit list according to an embodiment of the present disclosure.

Referring to FIG. 4B, the terminal determines the update intervals of the applications installed in the terminal at operation 411. Here, the applications are the applications needing periodic receipt of data from the outside. The SNS applications, such as Facebook and Twitter, are the representative application requiring periodic data update.

The terminal calculates the common synchronization timing for sharing a synchronized interval based on the update intervals of the applications at operation 413. The applications needing periodic updates may have different update intervals, and the basic synchronization unit interval is determined based on the greatest common divisor of the update intervals of the individual applications. If the terminal configures the greatest common divisor of the update intervals as the basic synchronization unit interval, then the common synchronization timing is calculated based on the basic synchronization unit interval. The update intervals of the individual applications are listed in the alarm list. At this time, the terminal synchronizes the start times of the updates of the applications.

If a network connection time of the application which is determined according to the common synchronization timing and the per-application update interval arrives, then the terminal generates an alarm signal at operation 415.

If the alarm signal is detected, i.e. if the network access time of the corresponding application arrives according to the common synchronization timing, then the terminal determines whether the network permit list exists, and retrieves the network permit list 223 in order to determine whether to allow update synchronization of the corresponding application at operation 417.

Here, the network permit list 223 lists the applications of which update synchronizations with the network are permitted. The network permit list 223 may be received from the outside via the communication unit 210 and/or may be designated by the user. At this time, only the applications listed in the network permit list 223 are allowed for connection to the network.

If the corresponding application is included in the network permit list 223, the terminal allows the corresponding application to connects to the network at operation 418. If the corresponding application is not included in the network permit list 223, the terminal blocks the network connection attempt of the corresponding application at operation 419.

For reference, the user may review and/or determine the applications needing periodic updates in order to add the applications not needing periodic updates to the network block list 222 and/or the applications needing periodic updates to the network permit list 223. The network permit list 223 may be received from the outside via the communication unit 210 and/or may be designated by the user.

FIG. 4C is a flowchart illustrating a common synchronization timing calculation procedure of the application update synchronization method according to an embodiment of the present disclosure.

The terminal determines the update intervals of the applications installed in the terminal at operation 421. Here, the applications are the applications needing periodic receipt of data from the outside. The SNS applications, such as Facebook and Twitter, are representative applications needing periodic data updates.

The terminal calculates the common synchronization timing for sharing a synchronized interval based on the update intervals of the applications at operation 423.

The applications needing periodic updates may have different update intervals, and the basic synchronization unit interval is determined based on the greatest common divisor of the update intervals of the individual applications.

The terminal monitors to determine whether a request for registering update interval of a new application is detected at operation 425.

If no update interval registration request is detected, the terminal maintains the common synchronization timing at operation 429.

If an update interval registration request is detected, the terminal calculates the greatest common divisor between the update interval of the new application and the common synchronization timing and determines whether the intervals are relatively prime at operation 427.

If the update interval of the new application and the common synchronization timing are relatively prime, then the terminal maintains the common synchronization timing at operation 429.

If the update interval of the new application and the common synchronization timing are not relatively prime, the terminal resets the common synchronization timing to the greatest common divisor between the update interval of the new application and the common synchronization timing at operation 428.

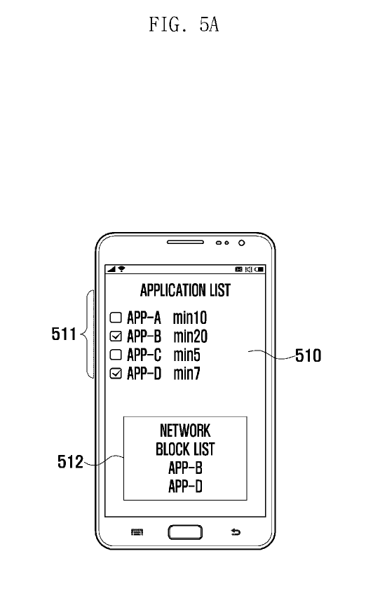

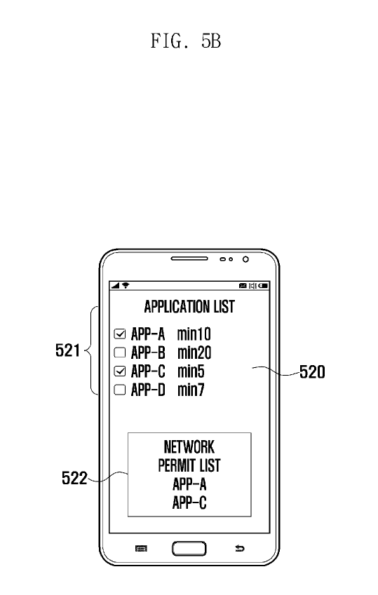

FIG. 5A is a diagram illustrating a screen display showing a menu for configuring a network block list for use in an application update synchronization method according to an embodiment of the present disclosure.

Referring to FIG. 5A, the terminal includes a touchscreen 510. The touchscreen 510 may include a display unit (not shown) and a touch panel (not shown) so as to act as both the input unit and the output unit. The touchscreen 501 is capable of displaying various screens corresponding the operations of the terminal, e.g. a media content playback screen, a call processing screen, a messenger screen, a game screen, and a gallery application screen, via the display panel. The touch screen 510 is also capable of generating an input signal to the control unit 230, in response to a touch gesture, made by the user, on the touch panel. Then the control unit 230 identifies the touch gesture and controls the terminal to take an action in response to the touch gesture.

The display unit may display and/or output the information processed by the terminal For example, the terminal in the communication mode may display a call processing-related User Interface (UI) or Graphic UI (GUI). The display unit also may display an image received in a video communication mode and/or captured in an image capture mode. The display unit also may switch between the landscape and portrait modes according to the rotation direction (or orientation) of the terminal.

The display unit may be implemented with any of a Liquid Crystal Display (LCD), a Thin Film Transistor LCD (TFT LCD), a Light Emitting Diode (LED) display, an Organic LED (OLED) display, an Active Matrix OLED (AMOLED) display, a flexible display, a bended display, a 3 Dimensional (3D) display, or any other similar and/or suitable display unit type. The display unit may be implemented in a transparent type and/or optical transparent type display screen.

The touch panel may be situated on the display unit in order to detect the touch gestures, such as a long press, a short press, a single-touch, a multi-touch, and drag gestures, made on the surface of the touchscreen 510. The touch panel detects a touch gesture, extracts coordinates at the touch position, and transfers the coordinates to the control unit 230. The control unit 230 may execute a function mapped to the area where the touch gestured is detected.

The touch panel converts a change of pressure and/or capacitance at a position on the display screen into an electric input signal. The touch panel may be configured to detect the pressure as well as the position and area of a touch. If a touch gesture is detected, the touch panel generates a signal corresponding to the touch gesture and provides the signal to a touch controller (not shown). The touch controller may process the signal and transfer the processed signal to the control unit 230. The control unit 230 may determine the position where touch gesture is detected on the touchscreen 510 based on the signal received form the touch controller.

The touchscreen 510 may display an application list 511 and a network block list 512, as shown in FIG. 5A.

The user may review and/or determine the applications needing periodic updates in the application list 511 and may select the applications of which periodic update options are disabled from the application list 511.

At this time, each application item of the application list 511 may be composed of the application name and its update interval. The application item may also present a brief feature concerning the network access interval of the application.

If an application is selected from the application list 511, then the touchscreen 510 presents the selected application item in the network block list 512.

FIG. 5B is a diagram illustrating a screen display showing a menu for configuring a network permit list for use in an application update synchronization method according to an embodiment of the present disclosure.

Referring to FIG. 5B, the terminal includes a touchscreen 520. The touchscreen 520 of FIG. 5B is identical with that of FIG. 5A in functionality.

Referring to FIG. 5B, the touchscreen 520 displays an application list 521 and a network permit list 522.

The user may review and/or determine the applications needing periodic updates in the application list 521 and may select the applications of which periodic update options are enabled from the application list 521.

At this time, each application item of the application list 521 may be composed of the application name and its update interval. The application item may also present a brief feature concerning the network access interval of the application.

If an application is selected from the application list 521, the touchscreen 520 presents the selected application item in the network permit list 522.

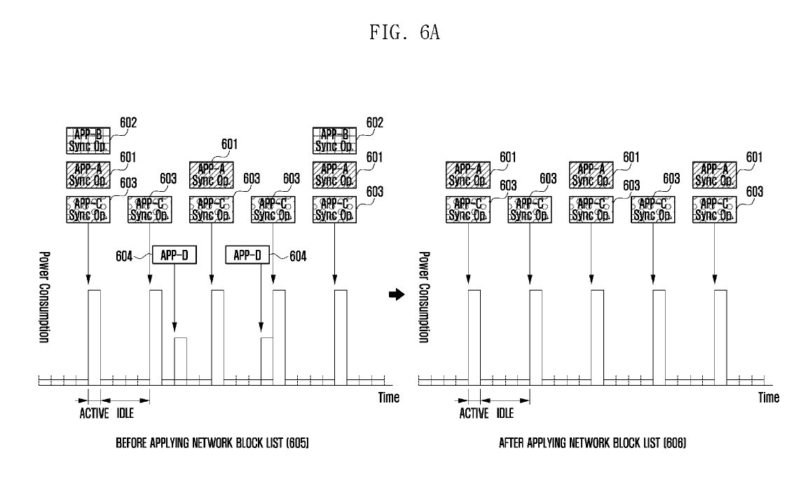

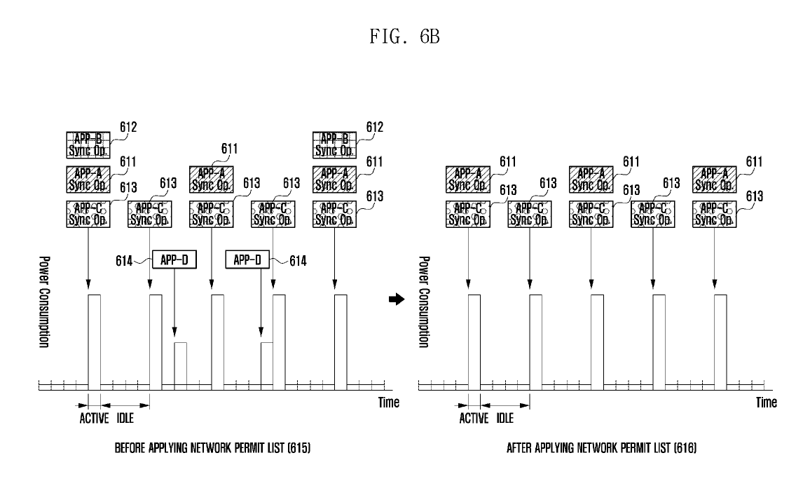

FIG. 6A is a diagram illustrating application update operations with and without applying a network block list in an application update synchronization method according to an embodiment of the present disclosure.

Referring to FIG. 6A, the application update operation without applying the network block list is performed as denoted by reference number 605. Here, it is assumed that the update intervals of the application A 601 is 10 minutes, of application B 602 is 20 minutes, and of application C 603 is 5 minutes. In this case, the greatest common divisor of the applications A, B, and C is 5 minutes. That is, the common synchronization timing of the applications A, B, and C is 5 minutes.

Then the basic synchronization unit interval of the applications A, B, and C, i.e. the common synchronization timing, is set to 5 minutes, and the individual applications perform updates at the intervals of 10 minutes, 20 minutes, and 5 minutes. Next, the update start times of the applications A, B, and C are synchronized. The Applications A, B, and C perform updates at the scheduled synchronization intervals.

At this time, the application A 601 performs update at every 10 minutes, the application B 602 at every 20 minutes, and the application C 603 at every 5 minutes. Since the update intervals of the applications A, B, and C are synchronized in a unit of 5 minutes, the applications A, B, and C start updates at the first update time simultaneously. Next, the application C 603, having the shortest update interval, performs an update after 5 minutes from the start time. Then the application C 603 performs a next update after 10 minutes from the start time. At this time, the application A 601, having the update interval of 10 minutes, performs an update along with the application C 603. The application B 602, having the update interval of 20 minutes, performs an update after 20 minutes from the start time and, at this time, the application A 601 and application C 603 may perform updates along with the application B 602.

In this state, if a new application D 604, having an update interval of 7 minutes, is registered, then the common synchronization timing and the update interval of the application D 604 are relatively prime. Accordingly, the application D 604 connects the network for updates at an interval independently of the applications A, B and C.

Since the application D 604 connects to the network at its update interval, independently of the basic synchronization unit interval of the applications A, B, and C, updates of the application D 604 increase the power consumption of the terminal.

However, if the synchronization controller 232 controls the applications A, B, and C by referencing the network block list 222, it is possible to reduce power consumption.

Referring to FIG. 6A, reference number 606 denotes the update operations with the adoption of the network block list. If the applications B 602 and the application D 604 are included in the network block list 222, then the terminal allows for the updates of the application A 601 and application C 603 while the terminal blocks the updates of the application B 602 and the application D 604. In this way, the terminal is capable of reducing unnecessary power consumption.

FIG. 6B is a diagram illustrating application update operations with and without applying a network permit list in an application update synchronization method according to an embodiment of the present disclosure.

Referring to FIG. 6B, the application update operation without applying the network permit list is performed as denoted by reference number 615. Here, it is assumed that the update intervals of application A 611 is 10 minutes, of application B 612 is 20 minutes, and of application C 613 is 5 minutes. In this case, greatest common divisor of the applications A, B, and C is 5 minutes. That is, the common synchronization timing of the applications A, B, and C is 5 minutes.

Then the basic synchronization unit interval of the applications A, B, and C, i.e. the common synchronization timing, is set to 5 minutes, and the individual applications respectively perform updates at the intervals of 10 minutes, 20 minutes, and 5 minutes. Next, the update start times of the applications A, B, and C are synchronized. The Applications A, B, and C perform updates at the scheduled synchronization intervals.

At this time, the application A 611 performs an update at every 10 minutes, the application B 612 at every 20 minutes, and the application C 613 at every 5 minutes. Since the update intervals of the applications A, B, and C are synchronized in a unit of 5 minutes, the applications A, B, and C start updates at the first update time simultaneously. Next, the application C 613, having the shortest update interval, performs an update after 5 minutes from the start time. Then the application C 613 performs a next update after 10 minutes from the start time. At this time, the application A 611, having the update interval of 10 minutes, performs an update along with the application C 613. The application B 612, having the update interval of 20 minutes, performs an update after 20 minutes from the start time and, at this time, the application A 611 and the application C 613 may perform updates along with the application B 612.

In this state, if a new application D 614, having the update interval of 7 minutes, is registered, then the common synchronization timing and the update interval of the application D 614 are relatively prime. Accordingly, the application D 604 connects the network for update at an interval independently of the applications A, B and C.

Since the application D 614 connects to the network at an update interval independently of the basic synchronization unit interval of the applications A, B, and C, updates of the application D 614 increases the power consumption of the terminal.

However, if the synchronization controller 232 controls the applications A, B, and C by referencing the network permit list 223, it is possible to reduce power consumption.

Referring to FIG. 6B, reference number 616 denotes the update operations with the adoption of the network permit list. If the applications A 611 and the application B 612 are included in the network permit list 223, then the terminal allows for the updates of the application A 611 and application B 612 while the terminal blocks the updates of the application C 613 and the application D 614. In this way, the terminal is capable of reducing unnecessary power consumption.

As described above, the application update method and apparatus of the present disclosure is capable of adjusting start times and intervals of synchronizations of the applications running on the terminal with different synchronization intervals, thereby preventing unnecessary operations of the applications and thus unnecessary power consumption.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for updating an application in a terminal, the method comprising:
determining update intervals of a plurality of applications installed in the terminal;
calculating a common synchronization timing based on the update intervals of the plurality of applications; and
determining, when an update time of an update target application arrives, whether to allow updating of the update target application according to at least one of a network block list and a network permit list.

2. The method of claim 1, wherein the at least one of the network block list and the network permit list is received from an external network or is stored in the terminal.

3. The method of claim 2, further comprising:
blocking, when the update target application is included in the network block list, the update of the update target application; and
permitting, when the update target application is excluded from the network block list, the update of the update target application.

4. The method of claim 2, further comprising:
permitting, when the update target application is included in the network permit list, the update of the update target application; and
blocking, when the update target application is excluded from the network permit list, the update of the update target application.

5. The method of claim 1, wherein the calculating of the common synchronization timing comprises calculating the common synchronization timing according to a greatest common divisor of the update intervals of the applications.

6. The method of claim 5, further comprising:
calculating, when a new application is registered, the greatest common divisor of the update interval of the new application and the common synchronization timing;
determining whether the update interval of the new application and the common synchronization timing are relatively prime based on the greatest common divisor; and
maintaining, when the update interval of the new application and the common synchronization timing are relatively prime, the common synchronization timing.

7. The method of claim 6, further comprising updating, when the update interval of the new application and the common synchronization timing are not relatively prime, the common synchronization timing with the greatest common divisor between the update interval of the new application and the common synchronization timing.

8. The method of claim 1, wherein the update intervals of the plurality of applications are configured by a user of the terminal.

9. The method of claim 1, wherein at least one of the network block list and the network permit list is configured by a user of the terminal.

10. A terminal for updating an application, the terminal comprising:
a storage unit configured to store at least one of network block list and a network permit list;
a control unit configured to determine update intervals of a plurality of applications, to calculate a common synchronization timing based on the update intervals of the plurality of applications, and to determine, when an update time of an update target application arrives, whether to allow updating of the update target application according to the at least one of the network block list and the network permit list; and
a communication unit configured to perform at least one of transmitting and receiving data of the update target application according to whether the application allows the update of the application.

11. The terminal of claim 10, wherein the control unit is configured to calculate the common synchronization timing according to a greatest common divisor of the update intervals of the applications.

12. The terminal of claim 11, wherein the control unit is configured to block, when the update target application is included in the network block list, the update of the update target application, and to permit, when the update target application is excluded from the network block list, the update of the update target application.

13. The terminal of claim 11, wherein the control unit is configured to permit, when the update target application is included in the network permit list, the update of the update target application, and to block, when the update target application is excluded from the network permit list, the update of the update target application.

14. The terminal of claim 12, wherein the control unit is configured to calculate, when a new application is registered, the greatest common divisor of the update interval of the new application and the common synchronization timing, to determine whether the update interval of the new application and the common synchronization timing are relatively prime based on the greatest common divisor, and to maintain, when the update interval of the new application and the common synchronization timing are relatively prime, the common synchronization timing.

15. The terminal of claim 14, wherein the control unit is configured to update, when the update interval of the new application and the common synchronization timing are not relatively prime, the common synchronization timing with the greatest common divisor between the update interval of the new application and the common synchronization timing.

16. The terminal of claim 12, wherein the network block list and the network permit list are received from outside or is stored in the terminal.

17. The terminal of claim 10, wherein the update intervals of the plurality of applications are configured by a user of the terminal.

18. The terminal of claim 10, wherein at least one of the network block list and the network permit list is configured by a user of the terminal.
